(19) United States
(12) Patent Application Publication
(10) Pub. No.: US 2024/0070897 A1
(43) Pub. Date: Feb. 29, 2024

(54) GEOPOSITION DETERMINATION AND EVALUATION OF SAME USING A 2-D OBJECT DETECTION SENSOR CALIBRATED WITH A SPATIAL MODEL

(71) Applicant: Anno.ai, Inc., Minnetonka, MN (US)

(72) Inventors: Matt Thomasson, Eden Prairie, MN (US); Michael Ramsey, Reston, VA (US); Wojciech Tomasz Klecha, Warsaw (PL)

(21) Appl. No.: 18/456,926

(22) Filed: Aug. 28, 2023

Related U.S. Application Data
(60) Provisional application No. 63/401,449, filed on Aug. 26, 2022.

(51) Int. Cl. G06T 7/70; G06T 7/20; G06T 7/60; G06V 10/74

(52) U.S. Cl. CPC G06T 7/70; G06T 7/20; G06T 7/60; G06V 10/761; G06T 2207/30241; G06V 2201/07

(57) ABSTRACT

A tracking system is used to determine geoposition of an object, such as a person, using images from a 2-D camera, in which pixels in the 2-D image have been assigned a 3-D position by pairing the camera image with a spatial model. A spatial model can be provided by a suitable 3-D imaging device, such as but not limited to a LiDAR system, though other types of spatial imagers are contemplated. The tracking system can use geoposition data to aid in reidentification of a person across multiple cameras, as well as determine behavior of people that are being tracked.

### CROSS-REFERENCE TO RELATED APPLICATIONS

This application claims the benefit of U.S. Provisional Patent Application No. 63/401,449, filed Aug. 26, 2022, which is hereby incorporated by reference in its entirety.

### TECHNICAL FIELD

The present disclosure generally relates to determining geoposition using images from object detection sensors, and more particularly, but not exclusively, to determining geoposition from images using an image-position model.

### BACKGROUND

Providing the ability to determine geoposition of an object based on two-dimensional images remains an area of interest. Some existing systems have various shortcomings relative to certain applications. Accordingly, there remains a need for further contributions in this area of technology.

### SUMMARY

One embodiment of the present disclosure is a unique system to determine geoposition of an object, such as a person, using 2-D camera image. Other embodiments include apparatuses, systems, devices, hardware, methods, and combinations for determining geoposition using an image-position model. Further embodiments, forms, features, aspects, benefits, and advantages of the present application shall become apparent from the description and figures provided herewith.

### BRIEF DESCRIPTION OF THE FIGURES

FIG. 1 depicts a measurement estimation system that receives a camera image and a spatial dataset to aid in determination of measurements.

FIG. 2 depicts coordinate frames and axes for use in pairing the camera image with the spatial dataset for use in the measurement estimation system.

FIG. 3 depicts an image of a foot point in a scene and the location of a camera that has imaged a scene.

FIG. 4 depicts the definition of a camera-foot vector.

FIG. 5 depicts the component of the camera-foot vector in the plane of the floor (the x-y plane).

FIG. 6 depicts the projection plane normal vector.

FIG. 7 depicts the projection plane constructed based on plane normal vector (FIG. 6) and foot point (FIG. 3)

FIG. 8 depicts the derivation of height using pixel locations and trigonometry.

FIG. 9 depicts a bounding box defined about a person detected in the camera image.

FIG. 10 depicts a mapping of pixels in the camera image to 3-D positions.

FIG. 11 depicts the distance to various pixels in FIG. 10.

FIG. 12 depicts the count of pixels on various distances.

FIG. 13 depicts the conversion of the count of pixels in FIG. 12 to dimensions, including the transformation of dimensions to estimated weight.

FIGS. 14-19 depict an alternative method to determine a distance.

FIG. 20 depicts an embodiment of a tracking system and object detection sensor used to track a person.

FIG. 21 depicts an embodiment of an image scene of a field of view of an object detection sensor.

FIG. 22 depicts an embodiment of a tracking system in communication with a plurality of object detection sensors.

FIG. 23 depicts a data store having data store records associated with different objects that have been identified.

FIG. 24 depicts an embodiment of a data pipeline useful to generate geoposition information related to a tracked object.

FIG. 25 depicts an embodiment of a computing system useful to practice the techniques described herein.

### DETAILED DESCRIPTION OF THE ILLUSTRATIVE EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Cameras are used to document and record numerous aspects of life. From entertainment, to medicine, to security, cameras are a ubiquitous part of lives in the 21st century. Cameras can be used in static installations or on moving vehicles and can capture high resolution images as well as moving film. Depending on the characteristics of the camera, such as field of view or resolution, images taken can be used to derive any number of useful attributes. Advancements in camera technology and image processing have led to image datasets that can yield useful information for subsequent data processing. Typically, such cameras are used to capture two dimensional (2-D) images.

In some settings, images from the cameras can be paired with spatial information of the environment of which the camera has imaged. Spatial information can include one or more fiducials within the environment that can be matched to an area of the camera image, whether that area is a grouping of pixels or a single pixel. In some settings it is envisioned that many tens to many millions of fiducials can be identified in the spatial information and paired with appropriate pixels. When the pixels from the camera images are paired with the spatial information of the environment, various insights as to physical measurements between points identified in the camera image can be made.

A variety of sensors can be used to capture the spatial information in whatever area is being observed by such a sensor. As in the cameras mentioned above, spatial sensors can be either fixed or moving (e.g., in an autonomous vehicle such as a self-driving car, uninhabited aerial vehicle, etc.). Examples of sensors structured to capture spatial information include a category called 3-D scanners. In one embodiment, a LiDAR imager can be used to capture spatial information. Data generated from the LiDAR include point clouds having millions of separate points corresponding to a particular part of a surface or object in the field of view of the LiDAR. Although reference will be made herein to LiDAR systems used to capture the spatial information, it will be appreciated that no limitation is hereby intended to other types of sensors useful to capture such information. For example, data generated from other sensors can also be used to create useful fiducials in a spatial information dataset, including but not limited to: stereoscopic cameras, cameras operating using photogrammetry techniques (e.g., LiDAR), cameras systems using AI powered depth mapping/estimation, Sonar, RADAR, RF methods (e.g., detecting the location of RF transmitters), and single-snap stereo fusion, to set just a few examples.

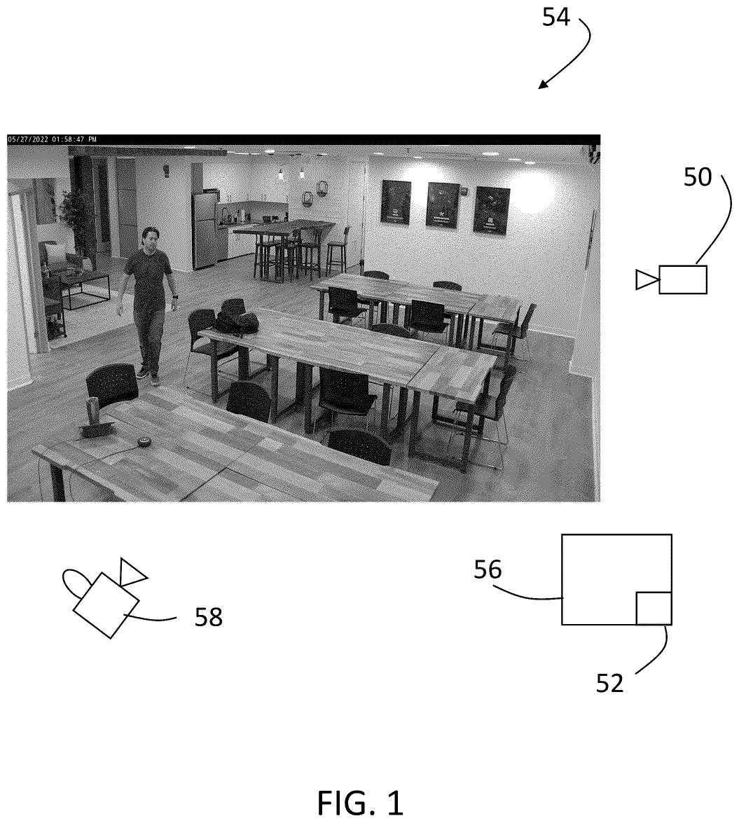

Turning now to FIG. 1, a system is disclosed having a camera 50, a spatial model 52 having spatially referenced fiducials generated from a suitable sensor such as but not limited to LiDAR, an environment 54 in which the camera and LiDAR are used to capture data, and a measurement estimation system 56 including a computing device having a processor with instructions on estimating physical measurements using the paired data of images from the camera 50 and the spatial model 52 derived from the suitable sensor. As used herein, the terms “estimating” or “measuring” generally refer to the process by which a distance between points is quantified and are used synonymously herein unless expressly required otherwise. As will be described further below, information from the camera 50, in conjunction with the spatial model 52, can be used to estimate measurements of items in the field of view of the camera, such as but not limited to measuring various attributes of a person including height. The estimates of height can be stored into a data store (e.g., a database) and used in subsequent camera images, or images from other cameras, as a technique to re-identify a person moving from camera to camera or re-appearing at a later time in the same camera. Attributes such as height can be used to quickly re-identify a person by eliminating other persons in the camera images that do not match the same measurement of the person.

FIG. 1 also depicts a spatial sensor 58 used to generate a dataset of the spatially referenced fiducials. The spatially referenced fiducials will be used with the measurement estimation system 56 along with other information described below to render measurement estimates. As stated above, the spatial sensor can be any suitable sensor capable of generating a dataset of spatial fiducials. It will be appreciated that the dataset, or eventual implemented model, can include fiducials expressed in a variety of coordinate systems. Such coordinate systems include any one of a local coordinate system, a geographic coordinate system, and a geocentric coordinate system. Further, the coordinate system can be expressed in a variety of forms such as Cartesian or polar form coordinates, with Cartesian being a typical choice. Conversions are possible between coordinate systems as needed for any given application and are well known.

In one example, the spatial sensor is a LiDAR system capable of collecting and generating information that can be collected in a collection of data a point cloud of data representing discrete points of a physical environment. For ease of description, the spatial sensor will be described with reference to a LiDAR system, but it will be understood that other types of spatial sensors can also be used other than LiDAR (as the discussion above demonstrated). No limitation is hereby intended by the discussion below that the spatial sensor be limited to a LiDAR system.

In some forms a LiDAR system is capable of generating and providing a dataset that includes a point cloud which represents the coordinates of a number of points in 3-D space, where the points represent a particular location in a scene being imaged by the LiDAR. Various locations in a scene are capable of having a ‘point’ assigned to them as is understood in the art. The LiDAR dataset can include other useful information as well, including the intensity of the laser light, the surface normal at each point in the cloud, etc. No limitation is hereby intended in the examples discussed herein of the relative scope of the dataset generated from the LiDAR system. Typically, however, the dataset will include multiple fiducials capable of being used for further processing herein. Whether the dataset of fiducials is provided directly from the LiDAR, or a less refined data is provided by LiDAR with subsequent data processing being required to generate a dataset of fiducials, it will be appreciated that a spatial dataset of the fiducials can be used further herein. Such processing required to compile the data into a referenceable spatial dataset is either provided directly from the LiDAR or can be readily prepared as will be understood in the art.

The term “referenceable” implies the ability to interrogate the dataset and determine appropriate information. For example, if the spatial dataset of fiducials (e.g., the point cloud) were plotted on a computer display, the dataset can be configured such that selection of a given point will yield a coordinate location expressed in an appropriate coordinate system and coordinate frame. For example, the dataset can be stored in any appropriate format and can be called/queried using any suitable methods. Thus, although the term “spatial dataset” has been used it will be appreciated that such dataset could alternatively deemed a “spatial model” or “three-dimensional mapping” with functionality provided to a user or other computer module of being queried with the identification of a point in the point cloud and a location of the point returned from the dataset and/or model. In some forms it will be appreciated that an identification of a position in the point cloud (e.g., an identification that results from user input or other automated mechanisms discussed further below) may result in more than one candidate point in the point cloud as associated with the chosen location in the point cloud. Any suitable number of approaches can be used to either identify an appropriate point corresponding to a query to the spatial dataset or interpolate between points to select a suitable location in space given the query to the spatial dataset. It will thus be appreciated from the discussion herein that the “referenceable spatial dataset” or “spatial model” generated from data sensed by any of the appropriate spatial sensors discussed herein and as discussed immediately above can be used as the spatial model 52 depicted in FIG. 1. Still further, the spatial model 52 can be a continuous 3D model, such as but not limited to a solid model akin to solid modeling in computer aided drafting tools. The spatial model can also, in some forms, be a surface model such as in a photogrammetry surface model, among potential others. One or more of these solid or surface models can, for example, be created by processing a point cloud of fiducials captured by an appropriate spatial sensor 58, while in other embodiments the solid model or surface model can be created using other tools and techniques. Thus, the spatial model 52 of FIG. 1 can be a referenceable model or dataset that, upon identification of a point in the point cloud or a spatial position in the point cloud or a spatial position in a solid model, can return a location expressed in a frame of reference with an appropriate coordinate system.

Although the spatial model 52 is depicted in FIG. 1 as being part of the measurement system 56, it will be appreciated that such a model can be maintained in another computing device, with appropriate communications between the measurement system 56 and the other computing device. Pairings of the spatial model 52 and the camera images can still be performed with appropriate methods of calling (e.g., an API call to a web accessible spatial model 52) for purposes of generating an estimate of physical length from the camera image.

The camera 50 depicted in FIG. 1 is structured to capture light in the visible wavelength are contemplated, but other wavelengths are also contemplated. For example, a camera structured to capture near-infrared wavelengths can also be used. No limitation is hereby intended that the recitation of a ‘camera’ is limited to a device used to capture visible wavelengths only. As used herein, therefore, the term “camera” can include any suitable imaging device capable of capturing an image of a field of view, at any specific wavelength or range of wavelengths. Further, such cameras can have any variety of resolution and magnification. In some situations, the cameras can be statically mounted in an environment, while in other situations the camera can be movable. In implementations where the camera is moveable, information related to the camera position and orientation (i.e., its ‘translation’ and ‘rotation’) can either be measured by the camera or inferred from techniques described later herein. In those forms in which the position and/or orientation is measured by the camera, such information can be used to augment or check or otherwise be used with or compared to information inferred from the techniques herein.

As will be appreciated, any given camera, or object detection sensor, will have properties associated with the design and construction of the camera. For example, cameras have a defined line of sight and field of view, which can either be fixed or variable depending on the configuration of the camera. Cameras also have an associated focal length, optical center, scale factor, resolution, skew, and tangential and radial distortion coefficients of the lens and other geometric distortion due to the lens. These type of camera specific parameters can be determined in advance of pairing with the LiDAR data, and it is often useful to calibrate the camera to account for one or more of these parameters. Such calibration can reduce and/or eliminate any distortions to the images provided by the camera when pairing with the spatial sensor (e.g., LiDAR) as described below.

Images captured by the camera 50 can be stored as image data in any suitable format and can also be referenceable. For example, digital images can be stored in pixelated form with each pixel having a numerical Red, Green, or Blue values associated with each pixel. In a 24-bit color scheme, with each of the Red, Green, or Blue allocated 8 bits, each pixel can have a color value derived from the contributions of each of the Red, Green, or Blue. The pixels are typically arranged in a grid format with a set number of vertical positions and a set number of horizontal positions. Thus, each pixel can be identified by its position within the image as well as the color value of each of Red, Green, or Blue.

Much like the referenceable data set from the spatial sensor described above, the image data is also referenceable in that the image from the camera can be interrogated by any appropriate function constructed to extract pixel information given a position on the image. For example, a function can be created to accept an input such as a mouse input from a user or a grid position from an automated system, where the function returns the pixel location and associated color information. As above, the term “referenceable” implies the ability to interrogate the image and determine appropriate information. Unlike the point cloud, it may not be necessary to interpolate between pixels if each is defined in a grid having zero space between pixels. In the event that an arrangement of an image includes spaces between pixels, similar techniques can be used as above to identify the closest pixel in the event a user or other automated system picks a position between pixels.

The camera image can be provided to the measurement estimation system 56, either in a raw format for subsequent calibration in the measurement estimation system, or a processed camera image can be provided to the measurement estimation system. The spatial dataset above along with the camera image are used by the measurement estimation system to estimate geometric measurements as will be discussed below.

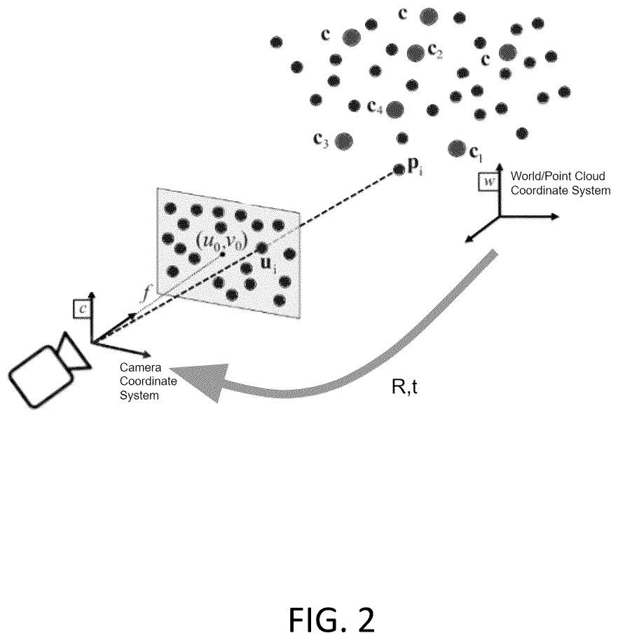

Turning now to FIG. 2, one step in the eventual pairing of the spatial dataset with the image dataset is illustrated. The axes illustrated in FIG. 2 represents the axes of camera (the “camera coordinate system”), the world coordinate system associated with the LiDAR data (often expressed as x, y, and z axes though not illustrated in FIG. 2), and a 2-D plane in which the image provided from the camera is expressed (using the coordinate frame expressed as u and v axes). The different datasets of camera image and spatial data are first aligned prior to calculating a camera pose. The datasets can be aligned using a number of different techniques, including selection of points of correspondence, for example a corner of a room, a window frame, a door jam, etc. Another technique to align the datasets include using edge detection and finding the best fit of datasets using optimization or other numerical techniques (e.g., using least squares fit). Yet another technique involves the use of machine learning and/or a deep learning model to align images which can, in part, also rely upon edge detection. Whichever alignment technique is used, once the datasets are aligned, a further technique known as Perspective-n-Problem can be used to determine the pose of the 2-D camera (i.e., the rotation and translation) of the camera relative to the spatial dataset. Solvers that implement the Perspective-n-Problem can be used to determine the pose of the 2-D camera. A further technique in determining camera pose includes the use of providing the camera image and spatial dataset to a deep learning model trained to back out camera pose. Determining the pose of the camera can be performed whether the camera is static or moving. The measurement estimation system 56 can be used to determine the pose of the camera in some embodiments.

Once the pose of the camera is known, each fiducial in the spatial dataset (e.g., each point in the point cloud) can be mapped to the picture plane which can also be performed by the measurement estimation system 56. Such a mapping can be represented by the notation (x,y,z)->(u,v), with x,y,z representing axes in the 3-D space of the spatial dataset, and u,v representing axes in the 2-D camera image data. Mapping every point in the spatial dataset, however, results in points being mapped to the picture plane that might otherwise be occluded given the position of the camera or would be outside of the frame of the picture (in the case of a large spatial dataset that exceeds the boundaries of a camera frame. Thus, a reverse dependency is also needed to provide a mapping from the picture back to the 3-D coordinate found from the spatial dataset. To map back from the camera plane, therefore, it is useful to (1) eliminate any point that is outside of the picture frame dimensions (i.e. eliminate only those points that fall within the picture frame/pixel resolution, such as [u∈(0, 1920),v∈(0, 1080)] to set forth just one nonlimiting example); and (2) select only the point closest to the camera to eliminate those points that would otherwise be occluded. Such elimination and selection can be performed in the measurement estimation system 56.

The mapping from 3-D to 2-D space, and the elimination of redundant points to provide a correspondence between a 2-D pixel and a 3-D location, results in a pairing between the datasets that ultimately permits the selection of a pixel in the 2-D plane with the calculation of a coordinate location based on the correspondence between 2-D and 3-D location. In other words, once the mapping and data elimination is performed, selection of a given pixel results in the determination of a 3-D location. A computational function can be made, therefore, that uses as input the selection of a pixel in an image and the coordinate location of the pixel is output from the computational function. Such a computation function can be referred to as an image-position model. It will be appreciated that the image-position model can be constructed using any of the techniques described herein that permit the determination of a 3-D location based upon selection of pixel in the 2-D image. If the camera characteristics change, such as a change in viewing angle, then the process described above can be used to determine an updated image-position model.

To obtain an estimated measurement using the 2-D camera image requires the selection of at least one pixel. The selection and subsequent calculations discussed below can be performed in the measurement estimation system 56. In one non-limiting example, the instant application can be configured to estimate the standing height of a person by first identifying a pixel at the person's foot, assuming the person is standing in the vertical plane, and making projections from the location of the foot. Computer vision (CV) techniques such as those capable of identifying the presence of a person can be used in the systems described herein. Various CV techniques are available to identify a person in a camera image, assign a mask to the person, and/or create a bounding box around the user. These techniques can be referred to as object detection, where any given technique can be useful to detect an object. These techniques can be specially designed to detect people, but other types of objects can also be detected and are contemplated herein. In the discussion further below, reference may be made to a person or persons that are detected, but no limitation is intended that the techniques disclosed herein are only applicable to people. Continuing with the example of using object detection to detect a person, whichever computer vision technique is used, a pixel can be selected at the foot of a person being imaged to begin the process to estimate the person's height. In some embodiments a pixel located in the bottom line of the bounding box closest to the sole of the person's foot can be the pixel selected to determine the 3-D coordinate location of that pixel. In other forms which use a mask, the pixel located at the bottom of the mask closest to the person's heel can be selected to determine the 3-D coordinate location of that pixel. In still further forms, the bottom line of the bounding box, and in some forms the midpoint of the bottom line, is chosen as the point from which height is to be measured. In whichever embodiment is used to determine the starting point, a vector between the foot point and the camera point is chosen to form a so-called foot-camera vector. Such a vector is pointing directly at the center of the aperture of the camera.

The image-position model described above can be used to collect data on the position of the person detected by the object detection. For example, a pixel location associated with the bottom of the detected person's foot can be selected for use with the image-position model for determining the 3-D position of the person. In some forms, the pixel location located at the lowest pixel location can be selected. Other locations can also be used for determining 3-D position of the person. For example, the sole of a person's foot can be detected, a line drawn though the sole of the person's foot from the heel to the toe, and a midpoint selected as the pixel location used for determining 3-D position of the person. The 3-D position can be referred to as a geoposition and recorded for tracking. As will be appreciated given the description herein, the geoposition can be in any variety of coordinate frames, and can be an absolute geoposition or a relative geoposition. Thus, the term “geoposition” generally refers to a geographic position including, but not limited to, a local geographic position or a global geographic position. The 3-D data collected from the spatial sensor can be output from the image-position model such that the image-position model adopts whichever coordinate system and type is used in the spatial sensor. Data processing can also be performed such that the image-position model outputs a different coordinate system and/or type than that used by the spatial sensor. In one nonlimiting form, the image-position model outputs 3-D position in a geodetic coordinate frame such as WGS-84.

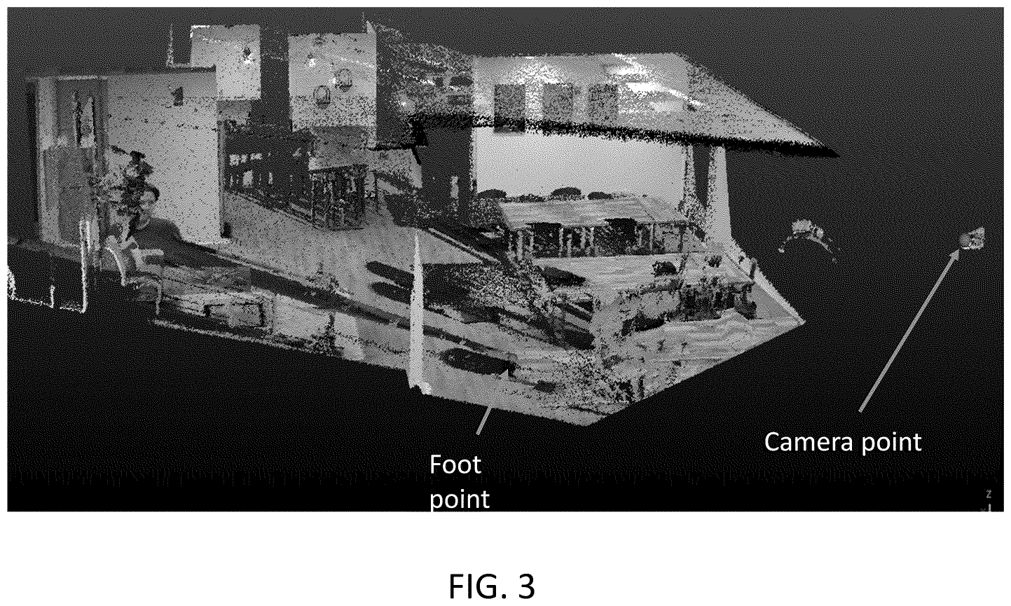

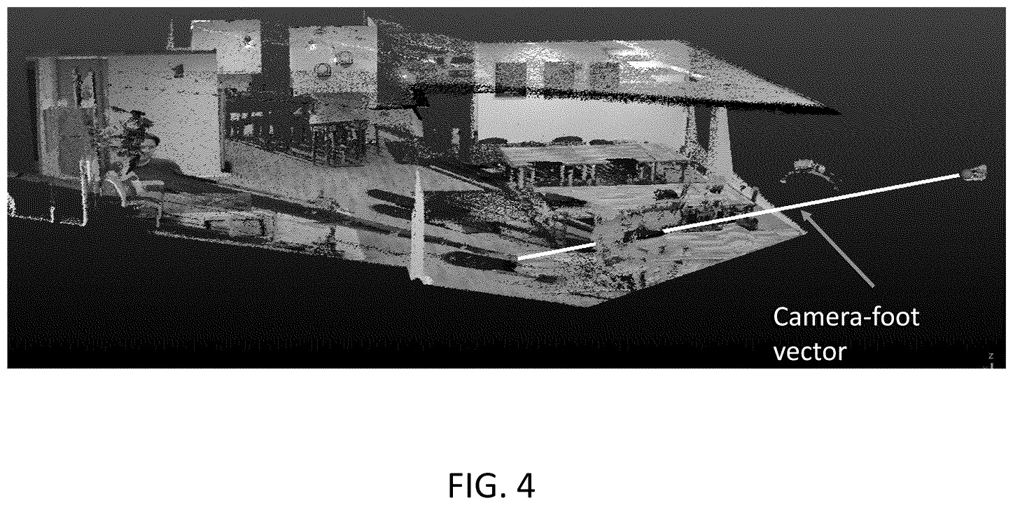

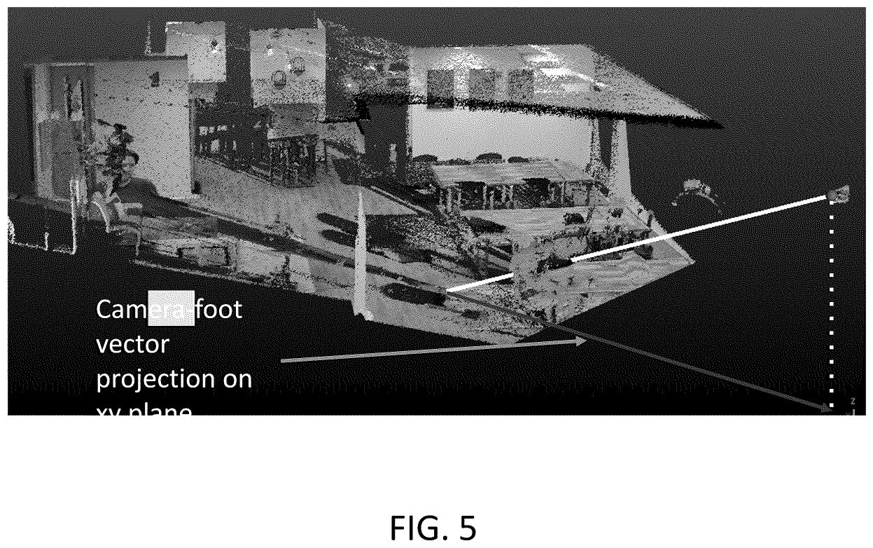

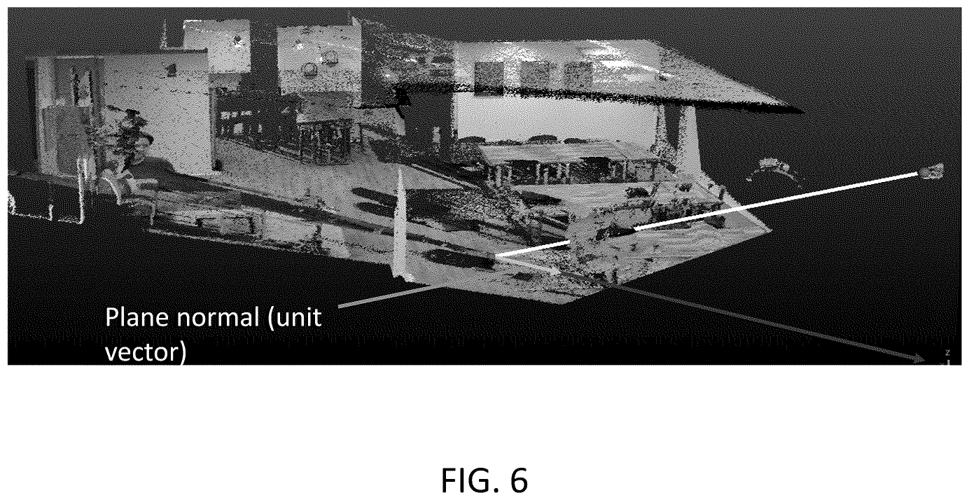

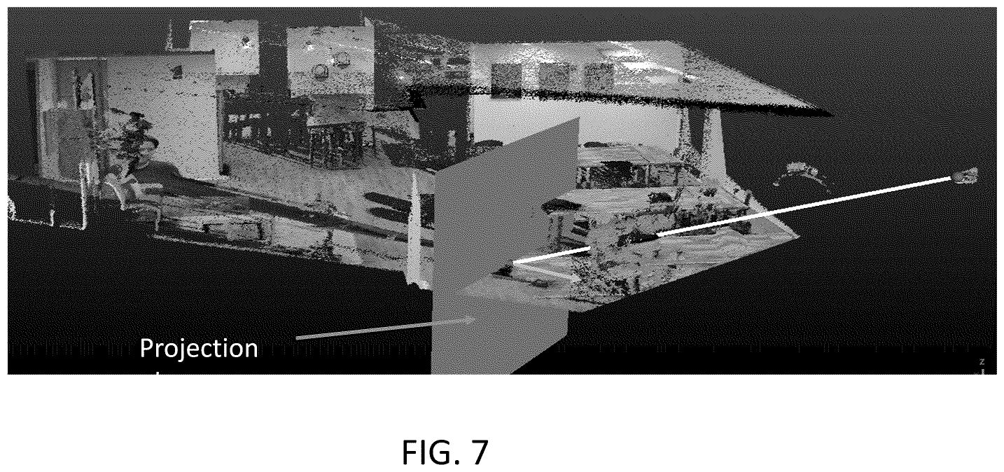

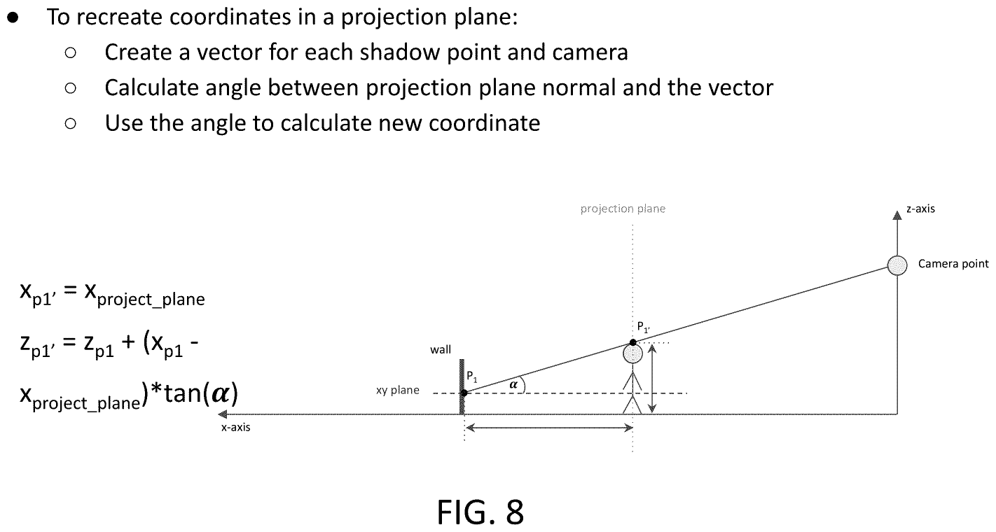

The steps of defining a foot point and defining a vector between the foot and the camera can be seen in FIGS. 3 and 4. FIG. 5 illustrates the projection of the camera-foot vector in the x-y plane (i.e., the plane in which the floor resides). FIG. 6 depicts the projection of a unit vector along the x-y component of the foot-camera vector. FIG. 7 depicts the construction of the projection plane defined by the plane normal vector in FIG. 6 and the foot point defined in FIG. 3. FIG. 8 depicts the algorithm to calculate a person's height, where the algorithm can be implemented in the measurement estimation system 56. The point P₁ is a point found by detecting a pixel above the person's head that lies behind the person and the location of which can be determined using the transformation discussed above. Such points can be a wall as depicted in FIG. 8, but other points are useful as well so long as position information can be determined using the techniques herein. The point P_{1′} is the location of the top of the person's head. An axis is depicted in FIG. 8 which lies in the direction of the unit vector discussed above. Although labeled as the “x-axis” it will be appreciated that such “x-axis” does not correspond to the spatial dataset collected using LiDAR but is labeled as the “x-axis” for convenience of discussion related to determining the person's height. As depicted in FIG. 8, the height of the person is the sum of the height at the P₁ location (dubbed z₁, in FIG. 8), and the difference between x location of the location of the point on the wall and the x location of the plane which is normal to the unit vector, where the difference is multiplied by the tangent of the angle formed between the x-axis and the vector between the point P₁ and the camera.

The technique described above can be extended to estimate other dimensions, such as but not limited to the breadth of a person. For example, when the person faces directly to the camera, the y-axis (i.e., the axis running into and out of the page in FIG. 8) can be used to estimate width at various points along a person's height).

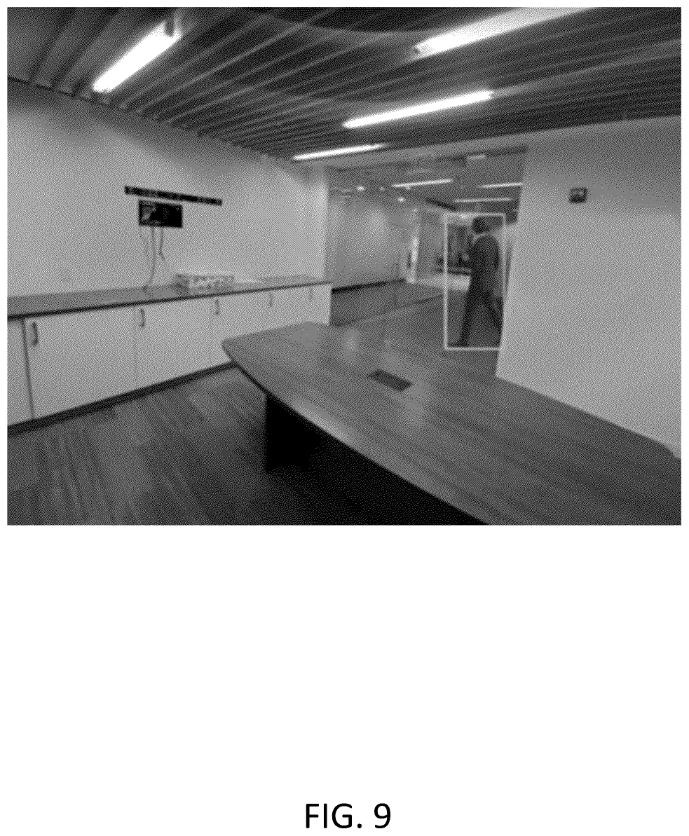

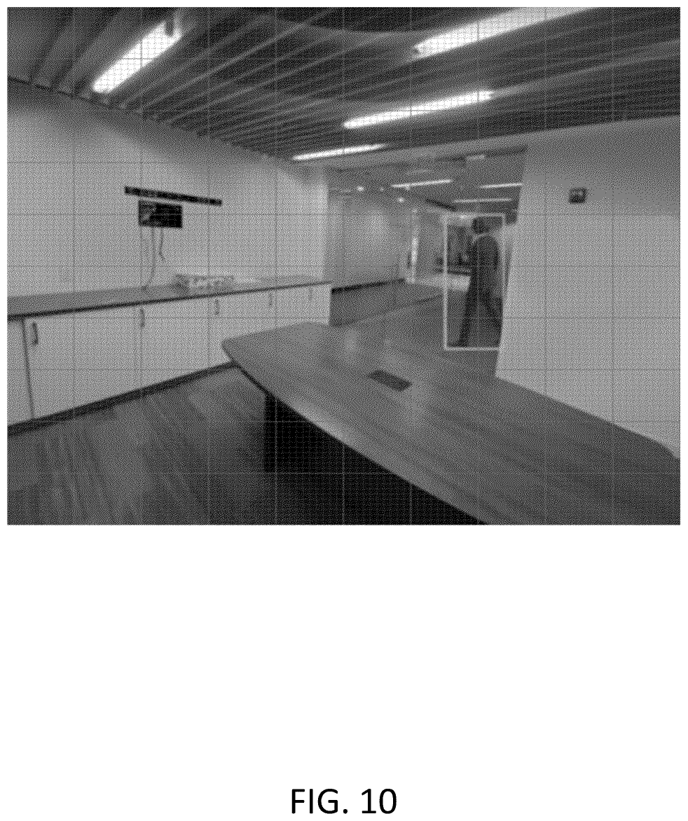

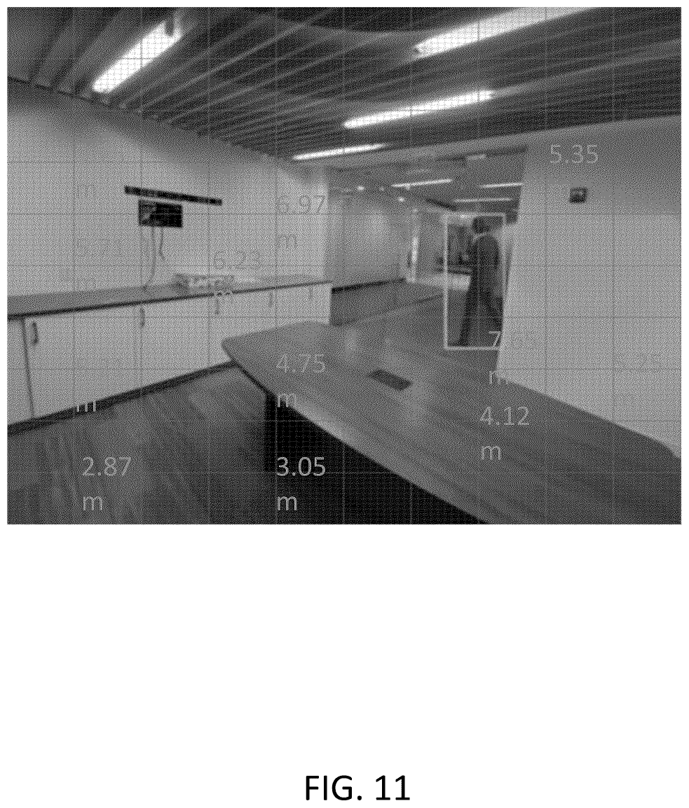

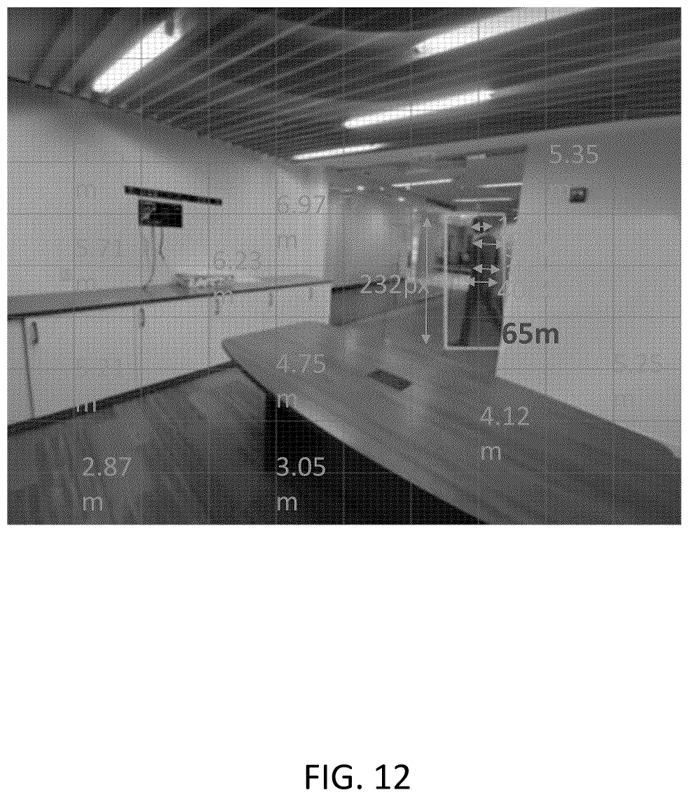

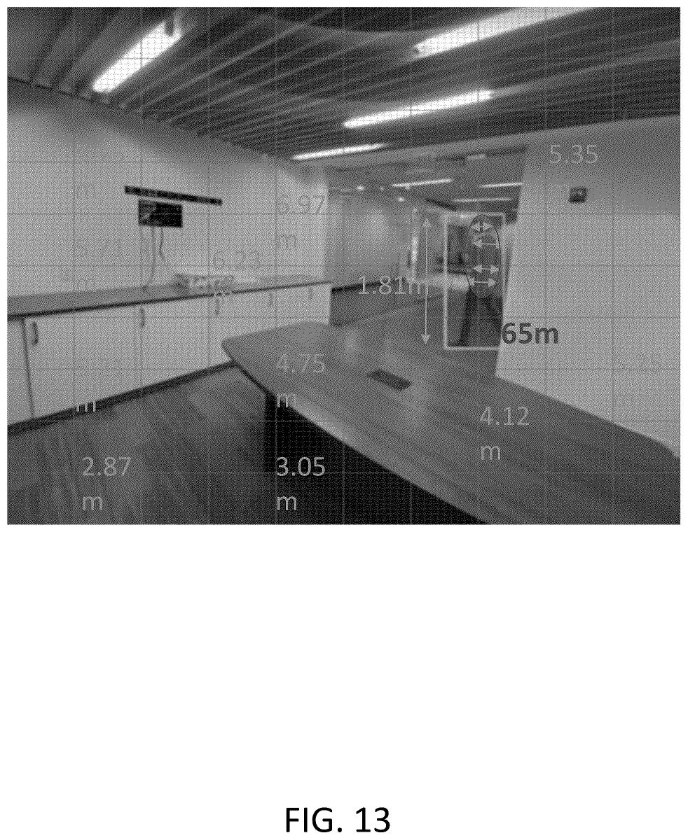

Further to the above, other techniques can also be used in the measurement estimation system 56 to estimate height and or other dimensions. FIGS. 9-13 illustrate the use of pixel location and pixel height to, using the measurement estimation system 56, determine various dimensions of a person by counting the pixels and multiplying the pixel height. FIG. 9 depicts a bounding box drawn around a person using techniques described above. FIGS. 10 and 11 illustrate the determination of the 3-D location of each pixel in the grid, also using techniques described above in pairing the spatial dataset with the camera image. The distances (in meters) illustrated in FIG. 11 are measurements of length from the camera to various pixels selected in the figure. FIG. 12 illustrates that when the measurement estimation system 56 determines the pixel which corresponds to the person's foot (can be estimated using any of the techniques above), then the person's height can be found by counting the number of pixels to the top of the person's head and multiplying by the pixel height. The same is true for the width of the person: count the number of pixels corresponding to a desired dimension such as width of shoulders and waist and multiply the number of pixels by the pixel size. FIG. 13 illustrates an example of estimating height shown as 1.81 meters, using a pixel located at the person's foot which is 7.65 meters along the floor between the foot and the location of the camera. Other models can be used in the measurement estimation system 56 to estimate a person's weight using the width measurements. Standard models can be used to correlate any of shoulder/waist/head/etc. dimensions to body weight.

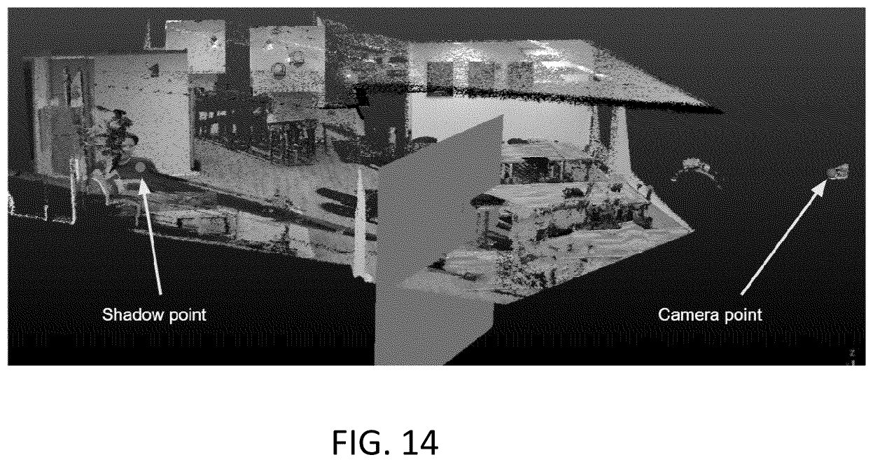

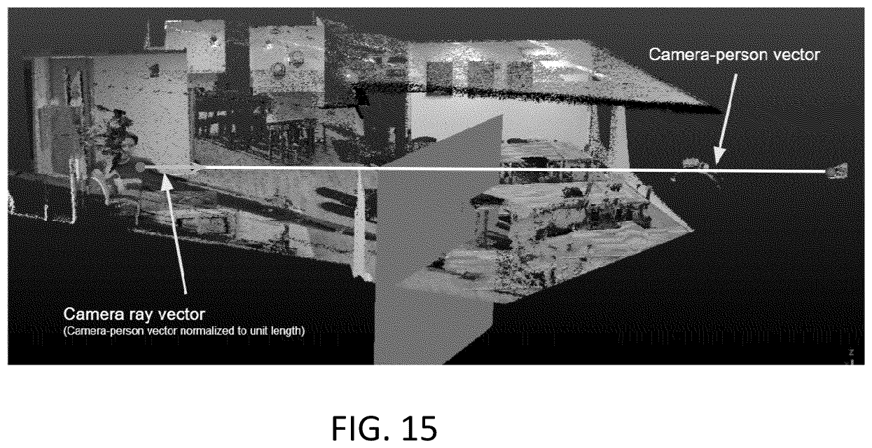

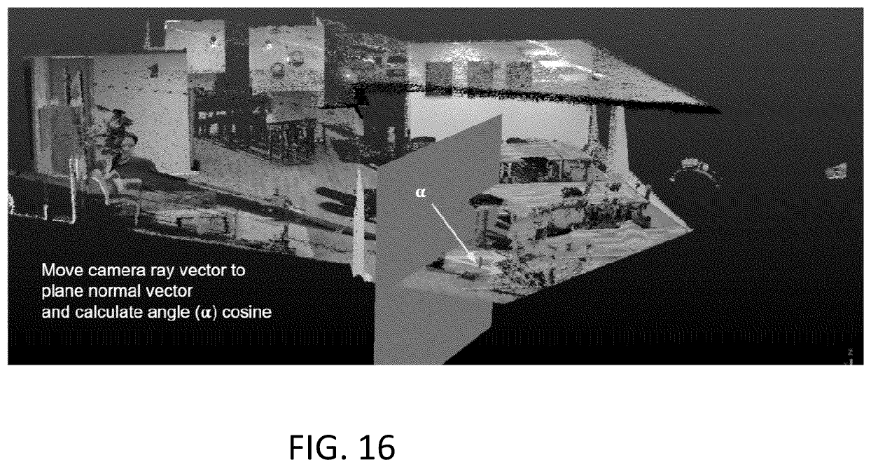

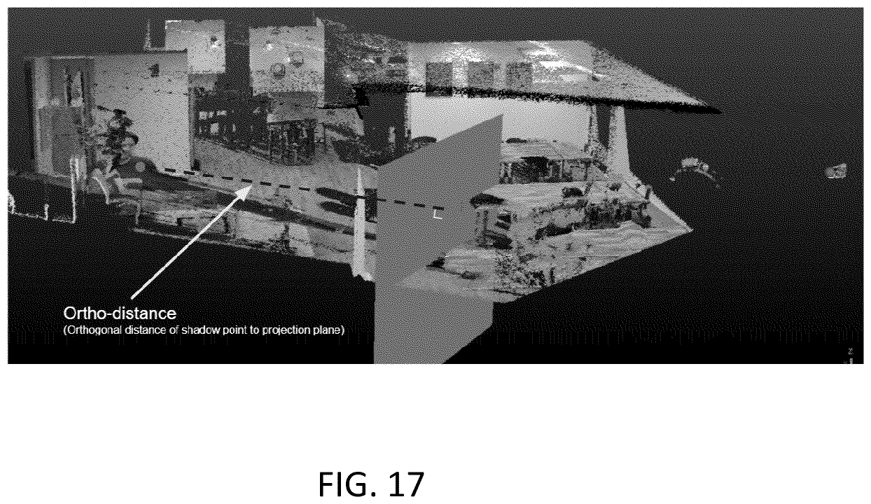

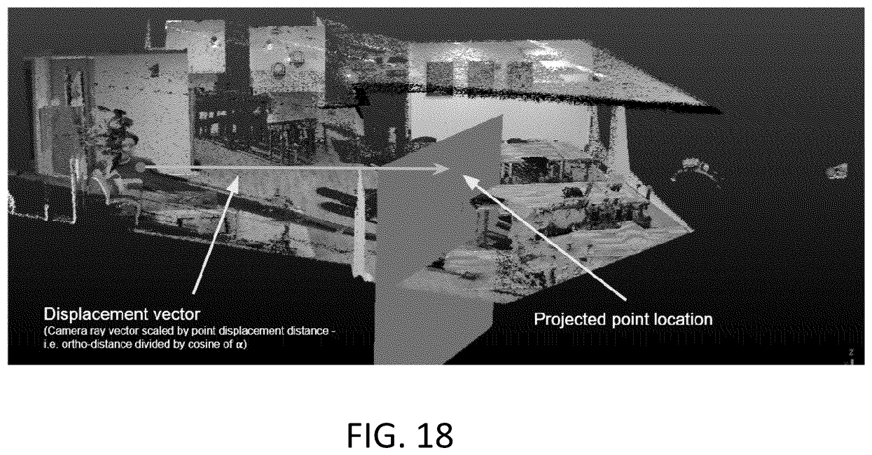

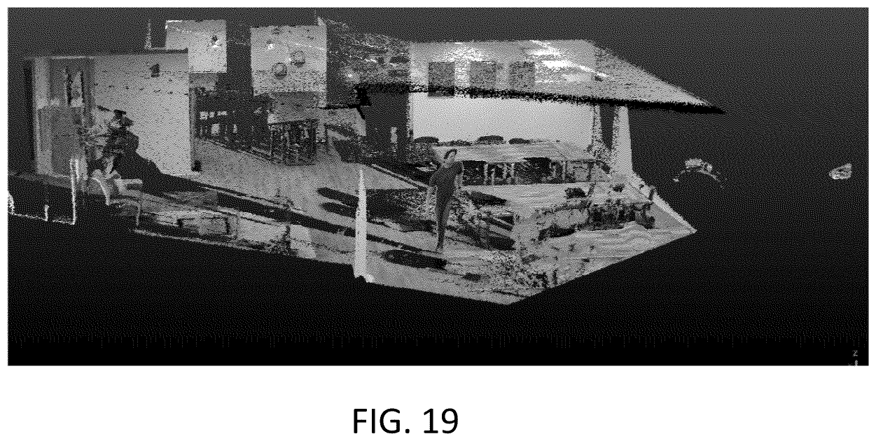

Further to the above, yet another technique can be used in the measurement estimation system 56 to estimate height or other dimensions. The technique begins similar to the technique above in FIGS. 3-8 by locating the focal point, or the point at which the foot intersects the floor and forming a vertical projection plane constructed by foot-camera vector. FIGS. 14 and 15 depict a ‘shadow’ of a person projected onto the background, where the ‘shadow’ is formed by simply pairing up each pixel of the person in the 2-D image (e.g., pixels identified as through segmentation) with a point in the point cloud of the spatial dataset. FIG. 15 further illustrates a camera-person vector drawn from the location of the camera to a given pixel of the projected shadow, as well as a camera ray vector which represents the camera-person vector that has been normalized to unit length. FIG. 16 represents the angle formed between the camera-ray vector of the point selected in FIG. 15 and the projection plane normal vector. A cosine is taken of the angle in FIG. 16 to obtain a scaling factor used in the next step. A so-called ‘ortho-distance’ which represents the orthogonal distance of the selected shadow point from FIG. 17 to the projection plane is calculated. FIG. 18 illustrates that a displacement vector is calculated which represents the camera ray vector scaled by the point displacement distance, i.e., the ortho-distance divided by cosine of the angle from FIG. 16 to determine the final projected point location on the plane. This process described above that selects a point in the ‘shadow’ and calculates various distances and angles is repeated for each point in the shadow. As above, the pixels corresponding to the ‘shadow’ can be found first through computer vision segmentation and the pixels of which are projected to form a shadow.

Once the measurement estimation system 65 has estimated geometric distances and/or weight using the techniques described above, various attributes can be assigned to an object detected in the camera image. For example, if a person traversing though the field of view information of the person tied to various measurements using the techniques disclosed herein can be observed and stored in a database as related to a particular person. A so called “feature vector” can be created for that person. It will be appreciated that the measurement estimation system 56 can be implemented in a computing device to yield additional feature vectors capable of being used to re-identify a person. Thus, the feature vector can be used to track the person among various cameras and/or among historical camera images. If, for example, a person moves from one camera to another, the feature vector can be used to assist in re-identifying the individual. The specific term “feature vector” is used throughout this discussion for ease of reference to refer to a vector useful in describing an object, but no limitation is hereby intended as to the specific method to determine the vector or the form in which the vector is stored. As such, although the discussion herein may refer to a “feature vector” for ease of reference, any use of term “vector” herein refers to vectors generated from representation learning. Any reference to “feature vector” will also be understood as being applicable to a representation vector.

Using the system and techniques described herein, a vector metadata associated with the feature vector can be formed. For example, a vector metadata associated with a specific individual can have a metadata of “height” entered which is based on the measured/estimated height provided using the system and techniques described herein. Any of the various measurements contemplated herein can be used as vector metadata, whether it is a person's height, shoulder width, leg length, etc. Thus, upon entering a new camera view, the system and techniques described herein can be used to estimate any variety of measures such as, but not limited to, height, weight, appendage measurement, posture, identification of which side of an individual is facing a camera, and many others and add that data to a vector metadata. Using the non-limiting example of height, upon estimating height and upon detecting other attributes of the person, a database of feature metadata can be scanned to find a likely match. To set forth just one example, if a person's height had been previously estimated from a first camera as being 6 feet tall and that height is entered as feature metadata, when subsequent camera images are used to estimate height of people in the images, if the system finds that a person in the subsequent images is also 6 feet tall then a search of the database of feature metadata of other known individuals can be filtered, rendering a faster and more accurate re-identification search.

The features of the embodiments described herein can be used alone and/or combined together to provide a number of different capabilities, including the following:
1. Combining one-time 3D data with real-time 2D to analyze objects such as people
   a. To include when 3D data is lidar
   b. To include when 3D data is a depth map estimated from stereo vision
   c. To include when 2D data is video
   d. To include when the analysis is in real time, and/or to include when the analysis is offline and batched.
   e. To include when objects are people, vehicles, pets, animals, aircraft, industrial equipment, military equipment, sports equipment, weapons, manufacturing equipment, facilities, buildings, security equipment, and safety equipment.
   f. To include when analysis is tracking objects over time, location, and camera
   g. To include when analysis is tracking one or more of a speed, trajectory, path prediction, or task identification
   h. To include when analysis is reidentification of objects over time, location, and camera
   i. To include when analysis is facial, gait, or pose recognition
   j. To include when analysis is behavior/activity recognition
2. Projecting video frames onto a reference point cloud to estimate physical characteristics of objects in the video
   a. To include when objects are people or vehicles
   b. To include when characteristics include physical characteristics such as height or weight or keypoint length for people
   c. To include when characteristics include physical characteristics such as make, model, color, type for vehicles
   d. To include when characteristics include calculated data such as distances between objects or points in the frame
3. Using #2 and #4 for the purposes of re-identification of objects
   a. To include when using distances to scale objects to a consistent size in machine learning training data for training re-identification embeddings or models—“chip normalization”
   b. To include using #2 a-c for object re-identification by way of reducing the scope of similarity search
4. Aligning a depth map with video frames to estimate physical characteristics of objects in the video
   a. To include when objects are people or vehicles
   b. To include when characteristics include physical characteristics such as height or weight or keypoint length for people
   c. To include when characteristics include physical characteristics such as make, model, color, type for vehicles
   d. To include when characteristics include calculated data such as distances between objects or points in the frame

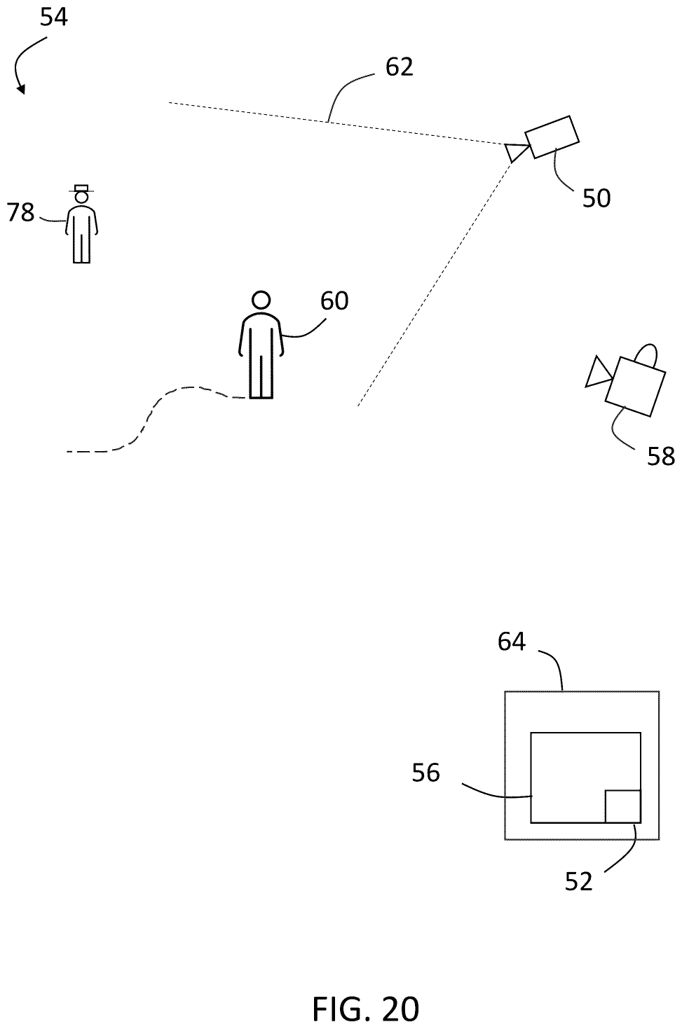

Turning now to FIGS. 20-22, an embodiment of the system depicted above is depicted in which an object, in this case a person 60, is imaged by an object detection sensor 50 having a field of view 62. As stated above, the object detection sensor 50 can take the form of the camera including any variations of the same described above. The spatial sensor 58 can be used to create a spatial model, or three-dimensional mapping 52, of the space in which the person 60 is traversing, where the spatial model 52. As noted above, the spatial sensor 58 can be used to create the spatial model 52, but need not be used in a real-time manner for tracking the person 60. In other words, a one-time spatial model, or three-dimensional mapping, can be created, after which the spatial sensor 58 need not be used again.

A tracking system 64 is depicted in the embodiment shown in FIG. 20 to emphasize the nature of the disclosure above that an object, such as the person 60, can be tracked. As will be appreciated, the tracking system 64 can take the form of a computing system with associated input/output, processor, and memory useful to realize the functionality set forth herein. The tracking system 64 can include the measurement system 56 and spatial model 52, although other variations will be appreciated given the description herein. The tracking system 64 is in data communication with the object detection sensor 50, and can use the three-dimensional mapping 52 in conjunction with image scene data generated from the object detection sensor 50, to determine position of the person 60.

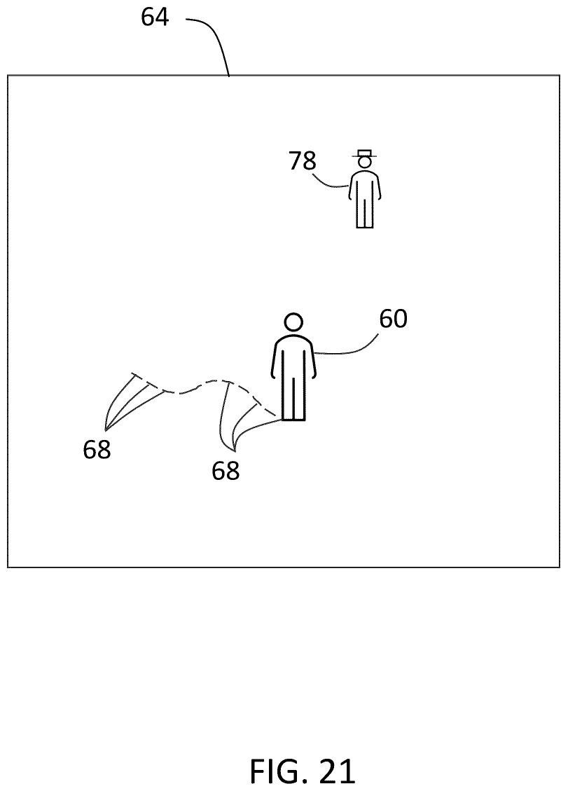

FIG. 21 illustrates an embodiment of image scene data representative of an image scene 64 of the field of view 62 generated from the object detection sensor 50. As the tracking system 64 monitors the person 60 traversing through the image scene 64 of the image scene data, the tracking system 64 is configured to record the geoposition of the person 60 for data analysis purposes. The embodiment illustrated in FIG. 21 depicts a trail of geopositions 68 represented by the dashed line that are detected by the tracking system 64 using the techniques described herein. The trail of geopositions 68 is used for illustration purposes and is not intended to convey that the same is included in the image scene data at any given time of capture of image scene data by the object detection sensor 50.

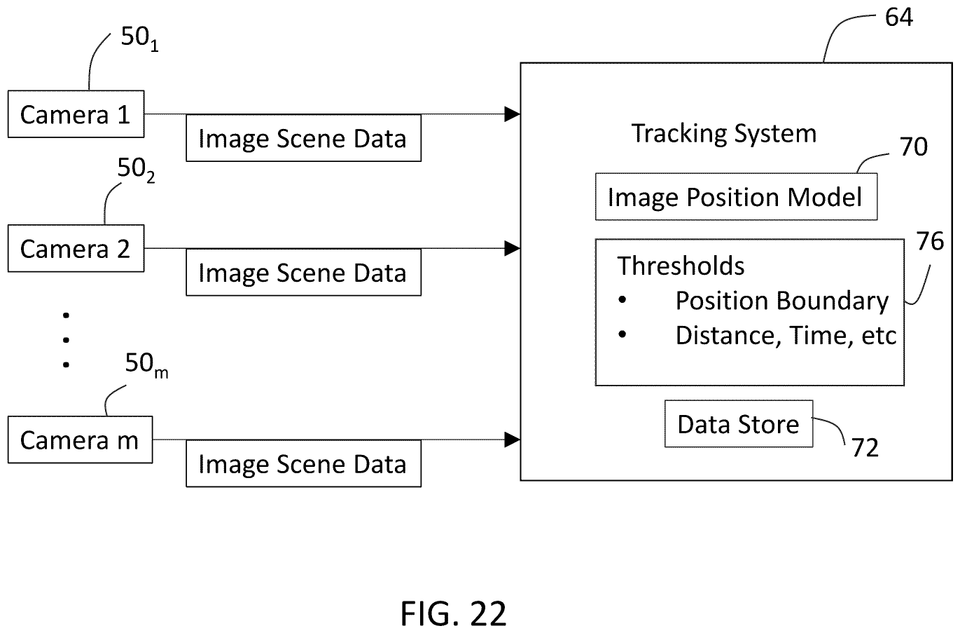

Though FIGS. 20 and 21 depict a single object detection sensor 50 used to capture image scene data, FIG. 22 depicts several other object detection sensors {50₁, 50₂, . . . 50ₘ} also used to capture image scene data. The object detection sensors {50₁, 50₂, . . . 50ₘ} depicted in FIG. 22 can be used to capture respective image scenes 64 that either overlap or are a subset of the image scene 64 of the object detection sensor 50 depicted in FIG. 20, it will be appreciated that the object detection sensors {50₁, 50₂, . . . 50ₘ} depicted in FIG. 22 can capture entirely different image scenes 64 that do not overlap or otherwise contain any feature of other image scenes. Further, the object detection sensors {50₁, 50₂, . . . 50ₘ} can take on any variety of form of camera 50 discussed hereinabove and need not be the same as each other.

The tracking system 64 can be used to track an object (e.g., person 60) through time and across different cameras {50₁, 50₂, . . . 50ₘ} for purposes of determining the geoposition of the person 60 over time. Image scene data from each of object detection sensors {50₁, 50₂, . . . 50ₘ} is received by the tracking system 64 for further data reduction using, as depicted in FIG. 21, an image-position model 70 of the type described above to determine the geoposition data of the person 60 over time. The tracking system 64 can include and/or be in communication with a data store 72 that records the geoposition 68 of the person 60 over time.

In some embodiments, the tracking system 64 can determine geoposition even if the feet of the person 60 is occluded. In those embodiments in which a height of the person is known and retained in the data store, the tracking system 64 can leverage the height of the person and extrapolate the geoposition of the feet based upon the height of the person 60 using the head as the starting point for measurement.

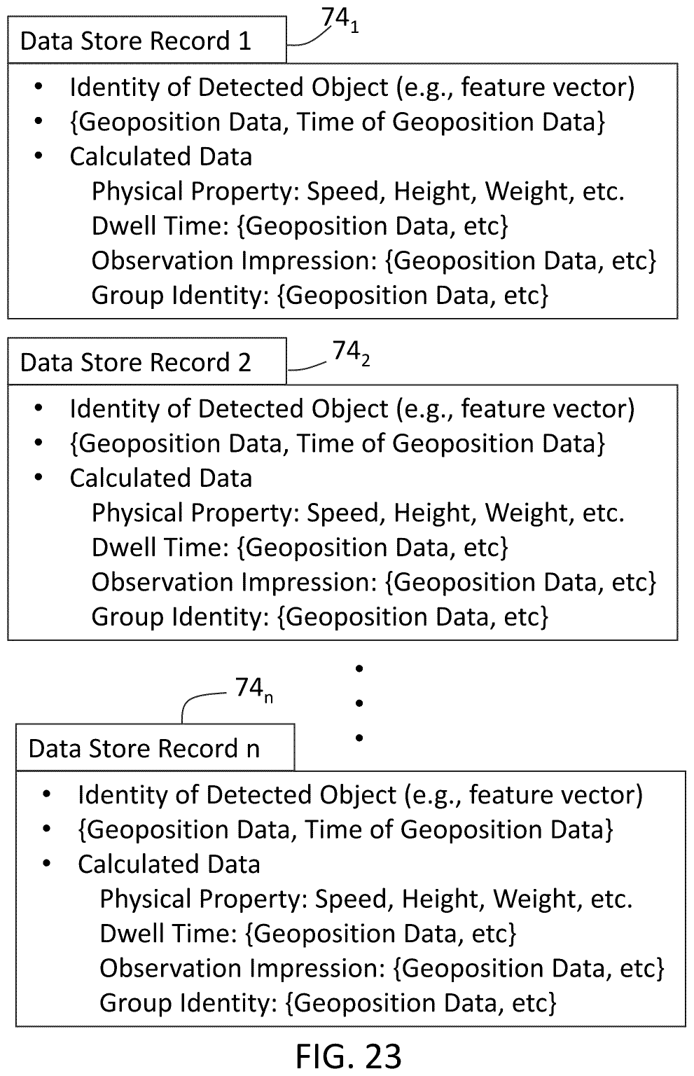

Referring now to FIGS. 22 and 23, the data store 72 that records the geoposition 68 of the person 60 can take any suitable form such as, but not limited to, relational databases, non-relational databases, key-value stores, etc. No limitation is hereby intended by the discussion herein and/or the depiction of an example data store 72 in FIG. 23. The data store 72 in FIG. 23 includes several different data store records {74₁, 74₂, . . . 74ₘ} that can include any variety of information related to any given person 60 that is detected. Each of the data store records {74₁, 74₂, . . . 74ₘ} correspond to a unique person 60 identified by the tracking system 64. When a new person 60 is identified a new data store record can be created to represent the new person 60. The tracking system 64 can include an extraction engine and an enrollment engine to enable the generation of an identifier for each of the data store records {74₁, 74₂, . . . 74ₘ}. The extraction engine may be configured to extract features from the image scene data (or the portion of the image scene data that represents the object) that represents the person 60, and generate a corresponding vector that includes one or more of the extracted features. In some forms, specific features can be extracted that permit identification based on facial, gait, or pose recognition. The extraction engine may provide the extracted feature vector to the enrollment engine. The enrollment engine may be in communication with the data store 72 to include the feature vector associated with the person 60. The process by which features are extracted and recorded are also described in more detail in U.S. Pat. No. 11,600,074, the disclosure of which is incorporated herein by reference in its entirety. In some embodiments, a cluster of feature vectors can be determined that relate to the person 60. As will be appreciated, any number of cameras can be used to generate data for recordation in the data store 72 for any given person.

The identity of the detected object depicted illustrated in each of the data store records {74₁, 74₂, . . . 74ₘ} can be a feature vector indicative of the person 60, or can be an identifier unrelated to the feature vector but nevertheless unique across all of the data store records {74₁, 74₂, . . . 74ₘ}. For example, the data store record 74₁ can have an identifier Person1 unrelated to the feature vector recorded in data store record 74₁ to set forth a very basic example. Thus, when reference is made herein to an identity of the detected person 60, the identity can refer to a unique identifier associated with the feature vector(s) associated with a person 60, or it can be a feature vector itself.

The geoposition data of the person 60 is also recorded in the data store record associated with the person 60. Any number of geoposition data can be recorded in the data store 72 based upon any number of times the person 60 is detected by one or more cameras. Each individual geoposition data from any given object detection sensor 50 can be recorded with an associated time to permit reconstruction of a path of the person 60 as well as calculated data based upon the geoposition data. In some forms the geoposition data can be recorded with an associated time but also with an associated camera, or cameras, used to capture the image scene data from which the geoposition data is determined.

Various calculated data can also be determined and subsequently recorded by the tracking system 64. For example, as discussed above, the measurement estimation system 56 can be used to determine a physical property, such as height of the person, which can be subsequently recorded in the data store 72. The measurement estimation system 56 can also be used to estimate weight. For example, the pixels associated with the detected person 60 can be used to estimate weight based upon a density stored in the tracking system 64. Other techniques can also be used to estimate weight. Speed of the person 60 can be determined based upon the geoposition data and time of geoposition data. For example, the speed between geoposition data points can be determined by a simple formula of distance between adjacent geoposition data points divided by the time between the adjacent geoposition data points. Refinements can be made to the calculated speed such as filtering or averaging the calculated speed. Calculated weight and calculated speed can be used to determine momentum.

Other calculated data can also be recorded in the data store 72. For example, the amount of time a person 60 is in the vicinity of a defined geoposition can be recorded as a dwell time. A defined geoposition can include a geoposition fence, or position boundary threshold 76, that defines a bounded area. The geoposition fence can include a line defined in the image scene data, where if a geoposition of the person 60 is on a first side of the line then the total amount of time on the first side of the line can be used to determine the dwell time. Any amount of time spent on the other side of the line may not be counted for dwell time. The dwell time can also include contiguous stretches of dwell time. If, for example, the person 60 moves from the first side to the second side, and then back to the first side, the dwell time can be recorded as a dwell time for a first contiguous stretch of time on the first side, and a dwell time for a second contiguous stretch of time on the first side. Dwell time can also include an aggregate time. It is envisioned that dwell time can be recorded based upon the geoposition data and the time associated with the geoposition data used to calculate dwell time. For example, dwell time can be recorded as a first instance of an amount of time that satisfied the position boundary threshold 76, the position boundary threshold 76, and the time (either start time, end time, or both) associated with the calculated dwell time. The dwell time can also be recorded with the camera 50 used to generate the image scene data upon which geoposition information is determined. As will be appreciated, the position boundary threshold 76 can take any variety of shapes, including a line, multiple lines, or closed shapes. The dwell time can be used, for example, to determine the duration of visit of a person 60 in a business, such as by recording the time the person 60 has passed the entrance into a business and the time the person passed back through the entrance to exit the business. Recordation of the dwell time permits tracking large numbers of people over multiple time periods.

Dwell time can also be determined on the basis of a path prediction. If a person 60 moves out of the image scene and then back into the image scene at a later time, dwell time can be calculated as the time period between when the person left the image scene and either returns to the image scene, or appears in another camera. Such determinations can be helpful, for example, in situations in which a camera does not fully capture the entry of a person into an enclosed space but otherwise captures the person leaving the image scene and returning to the image scene. The disappearance of the person 60 from the image scene and reappearance either to the same image scene or a different image scene, can be used as a proxy for the dwell time the person 60 spent in an enclosed space (e.g., such as a shop). If geoposition data of a person 60 is tracked over a time period for tracking prior to leaving an image scene and the geoposition data indicates that a trajectory of the person is oriented in a direction out of view of the camera and toward the enclosed space, then such condition can be used to determine a dwell time. For example, if a person exits an image scene, the tracking system 64 can evaluate geoposition data over a trajectory tracking time period (e.g., three instances of time such as consecutive times of raw data or consecutive times of reduced time frequency data) to form a path prediction and determine whether the trajectory of the person is reducing a distance to a position boundary located at or near the edge of the image scene. Other techniques can also be used to determine whether the trajectory of the person is trending toward a position boundary. If the path prediction shows a reduction in distance to the position boundary at or near the edge of the image scene (or determined using any other suitable technique), then the time at the last geoposition data can be used as a starting time for dwell time. The reemergence of the person 60 into the image scene, or into an image scene of another camera 50, can be the end time for dwell time purposes.

An observation impression can also be determined similarly to dwell time through use of a position boundary threshold 76. The position boundary threshold 76 used to determine an observation impression can be the same or different than the position boundary threshold 76 used to determine dwell time. The amount of time (e.g., total time, contiguous time, etc.) similar to the determine of dwell time can, but need not, be recorded. In some embodiments, the observation impression can be a Boolean that represents whether the position boundary threshold 76 is satisfied or not. The Boolean can be recorded along with the time (either start time or end time) associated with the geoposition data that satisfies the position boundary threshold 76. Thus, the observation impression can include multiple indications that the position boundary threshold 76 is satisfied based on the geoposition data recorded in the data store record. The observation impression can be used, for example, to determine whether a person 60 has approached an advertisement close enough to have seen the advertisement. Recordation of the observation impression permits tracking large numbers of people over multiple time periods.

Similar to the above-discussed dwell time and observation impression, other metrics can also be determined. For example, in the context of a shopping mall, using a position boundary it will be possible to determine which store(s) in the shopping mall a person 60 visits. Data can be recorded in the data store records 74 of which store(s) a person visits, and the duration of each visit. If the time of store visit is also recorded, it will be possible to determine a time ordered ranking of the stores that are visited. The tracking system 64 can also be used to determine the number of occurrence of “first store visited” over a defined period of time to determine which store in the shopping mall has the greatest number of “first store visits.” Another example includes foot traffic. Since the tracking system 64 can be used to identify unique persons 60, total number of visitors can also be generated from an inspection of the data store records 74. Another example includes using the tracking system 64 to determine the diversity of shops that a person 60 visits in a shopping mall, and if that diversity includes competitors. If a shopping mall includes two separate tenants that are competitors, such as anchor tenants in a large shopping mall, the tracking system can inspect the data store records 74 to compare, given an identification of the competitors, which store was visited first and in which store the person 60 spent the most time.

A group identity can also be determined, at least in part, similarly to dwell time through use of a position boundary threshold 76. The position boundary threshold 76 used, at least in part, to determine group identity can be the same or different than the position boundary thresholds 76 used in either of dwell time or observation impression. group identity can be determined if multiple people are traveling together and satisfy a position boundary threshold 76. In some forms, the position boundary threshold 76 is satisfied based not only on a geoposition relative to the position boundary threshold 76, but also a total time relative to a group time threshold 76. For example, persons that happen to walk next to one another but are not otherwise in the same group may satisfy the position boundary threshold 76 but not the group time threshold 76. The data store records {74₁, 74₂, . . . 74ₘ} that satisfy both the position boundary threshold 76 as well as the group time threshold 76 can be recorded in their respective data store records {74₁, 74₂, . . . 74ₘ} with a group identity. The group identity can be accompanied with a time (e.g., either start time or end time) associated with the identification of the group. The group identity can be any type of identifier, such as Group1, for example.

Data calculated above can also be used to confirm the identity of a person 60. For example, when a person 78 is detected by an object detection sensor 50 and a feature vector is extracted, the extracted feature vector can be assigned a preliminary identification which is subject to further verification. If a feature vector extracted from an image scene data of a person 78 preliminarily matches a feature vector stored for person 60 (e.g., matches within a threshold value), a verification step can be used to determine whether geoposition data 68 of person 78 should be recorded with the data store record associated with person 60. The verification step can include the determination whether the geoposition of person 78 satisfies a physics threshold such as a speed limit. If the recorded geoposition data of person 60 at a time near to the recorded geoposition of person 78 requires an excessive speed of travel (e.g., it fails to satisfy a speed threshold) to move between the recorded geoposition of person 60 and the geoposition of person 78, then the geoposition data of person 78 will not be recorded in the data store record associated with person 60. In this way, though the feature vector extracted for person 78 initially matches a feature vector of person 60, a test based upon physics, using a physics threshold, can be used to confirm whether the geoposition data for person 78 is recorded in the data store record of person 68. Other types of physics thresholds can also be used, such as the presence of walls that physically separate one space from another, and although a determination straight line speed may not violate a speed limit, the presence of the wall dictates that the preliminary match of the feature vector of person 78 with person 60 cannot be used.

It will be appreciated given the description above, that objects such as people can be tracked, identified, and reidentified based on geoposition information determined by the tracking system 64 as well as data calculated from geoposition information determined by tracking system 64. The person 60, appearing across different cameras 50 or appearing at different times in the same camera 50, can be reidentified using feature vectors and either confirmed as being the same person based on physics thresholds or confirmed as not being impossible that it is the same person. Different people, such as person 78, can be flagged as an ‘impossible traveler’ based on the test of geoposition data using the physics threshold. Such tracking can permit the creation of a label, recorded in the data store record (and possibly recorded in the data store as a function of time relative to the geoposition data), that the detected person 60 is the identical traveller, or is an impossible traveller. The label can be referred to as a travler detection label. Using labels a traveler detection label, such as, for example, “identical traveller” or “impossible traveller” (or analogs such as “identT” and “imposT,” respectively), permits record ratio of confirmation of the same person in an image scene of a camera 50, or across image scenes from multiple cameras. Use of such confirmation permits labeling, with an associated confidence, for future training purposes such as in future training of in identifying the person 60 through the tracking system 64 or any constituent part of the tracking system (e.g., object detection, feature extraction, etc). This process can be done by the tracking system 64 in an automatic manner (so called “auto-label”). In those embodiments in which real-time tracking is used, such labels can be applied to a display from which is used to present the image scene data to an end user based upon the tracking, identification, and reidentification. The ability to confirm the identity of a person and automatically label a person 60 in an image scene depicted on a display improve the ability to reliably track the person 60. Further to auto-labeling a person, any other metrics can also be labeled on the display for the person 60, including any of the aforementioned data such as height, weight, identity from the data store, group identity, etc. Textual display of any of the metrics or data can be used in lieu of, or in addition to, color coded indicia overlaid on the image scene when displayed on a monitor or other suitable display.

The identification of identical traveler and impossible traveler can also be used in in lieu of, or in addition to, feature vector extraction and comparison. If a person 60 is tracked as an object, and as the person 60 moves from one image scene of a camera 50 to different image scene of another camera 50, the “identical traveler” and “impossible traveler” technique described above can be used to mark the detected person 60 as being the same person from image scene to image scene and/or in overlapping image scenes from two or more cameras. The geoposition of the detected object from the first camera and from the second camera can be recorded in the same data store record 74 from both cameras if the detected person that moves from one camera to the next satisfies the conditions of an “identical traveler” (see above, for example). If, however, the detected object that moves from one camera to another cannot be the same object because it fails to satisfy the conditions of a “identical traveler,” then the geoposition data determined from one camera to the next camera will not be recorded in the same data store record 72. Similarly, if two or more cameras 50 have overlapping image scenes, the geoposition data captured from each can be recorded to the same data store record 74 if the detected person 60 walks into the overlapping area of the respective image scenes from the different cameras 50. The tracking system 64 can determine that the detected objects in the overlapping image scenes are the same person 60 if the geoposition data matches, within a position match threshold and within a match time threshold. If both thresholds are satisfied, then the geoposition data from each camera 50 related to the object 60 are recorded to the same data store record 74.

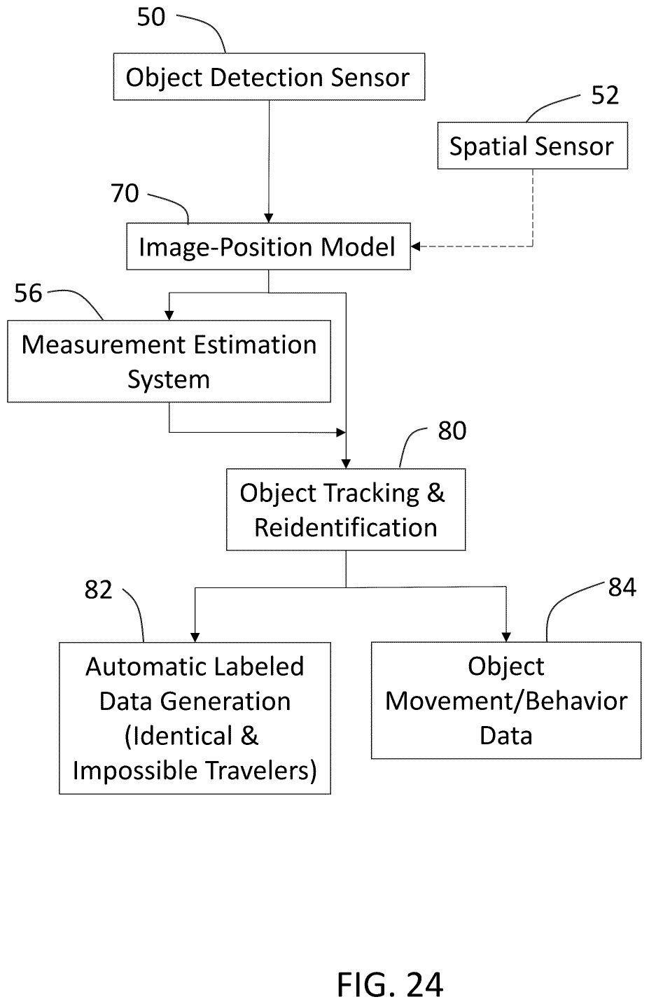

FIG. 24 depicts one embodiment of a data pipeline useful to practice the techniques disclosed herein. An object detection sensor 50 can be used to generate image scene data which is passed to the image-position model 70. The image-position model 70 can be generated using data from spatial sensor 52. The spatial sensor 52 is shown as in dotted-line communication with the image-position model 70 which indicates that the spatial sensor 52 need not be used at every instance the object detection sensor 50 is used. Rather, it is contemplated that the spatial sensor 52 need be used, for example, only once to aid in the creation of the image-position model 70. The tracking system 64 can use object detection to detect, for example, a person, from which geoposition data can be generated and various other measurements can also be generated using the measurement estimation system 56. The object can be tracked, identified, and reidentified at block 80. Block 82 can confirm a preliminary identification of an object using a physics threshold discussed above. Additionally, and or alternatively, object movement data can be determined at block 84 using the techniques described above.

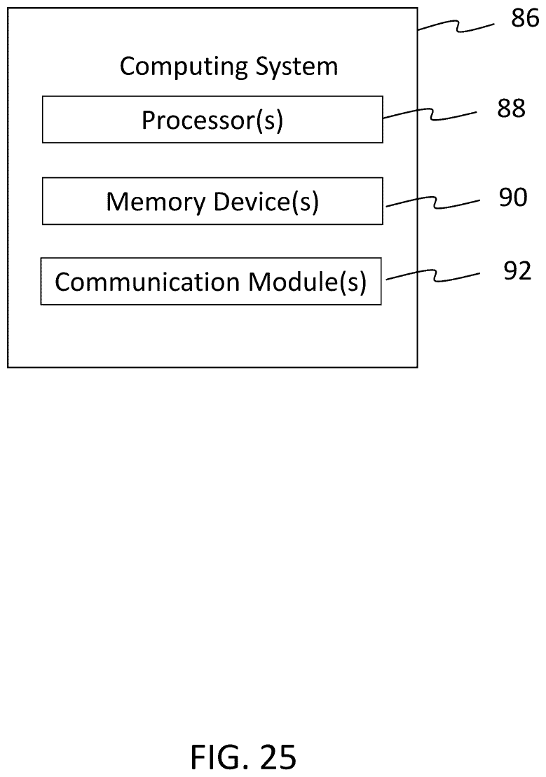

Referring now to FIG. 25, embodiments of the systems and methods disclosed herein may include and/or be executed by a computing system 86 communicatively coupled to one or more of object detection sensors 50. In general, the computing system 86 may comprise any suitable processor-based device known in the art, such as a computing device or any suitable combination of computing devices. Thus, in several embodiments, the computing system 86 may include one or more processor(s) 88 and associated memory device(s) 90 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 90 of the computing system 86 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 90 may generally be configured to store suitable computer-readable instructions that, when implemented by the processor(s) 88, configure the computing system 86 to perform various computer-implemented functions, such as one or more aspects of the methods or algorithms described herein (e.g., receipt of image scene data and execution of image-position model, determination of geoposition, object detection, execution of the measurement estimation system, auto-labeling, etc.). In addition, the computing system 86 may also include various other suitable components, such as a communications circuit or module, one or more input/output channels, a data/control bus and/or the like. With respect to one or more input/output channels, the computing system 86 can be operated using any suitable input device (e.g., a keyboard)(and can provide output (e.g., to a display monitor). It should be appreciated that, in several embodiments, the computing system 86 may correspond to a stand-alone computing system separate and apart from other computing systems.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A non-transitory computer-readable medium storing one or more instructions that, when executed by one or more processors, are configured to cause the one or more processors to perform operations comprising:
detecting an object in an image scene data to create a detected object, the image scene data representing an image scene in a field of view of at least one object detection sensor;
determining a current geoposition data of the detected object using an image-position model, the image-position model determined by calibrating the at least one object detection sensor with a three-dimensional mapping provided by a spatial sensor;
determining an identity of the detected object to create a preliminary identity;
identifying a data store identity of a plurality of data store identities that matches the preliminary identity of the detected object, the plurality of data store identities corresponding to identities of a plurality of detected objects; and
recording the current geoposition data of the detected object with a data store record associated with the data store identity that matches the preliminary identity of the detected object if a physics model threshold of the detected object is satisfied.

2. The non-transitory computer-readable medium of claim 1, wherein when the current geoposition data is recorded in the data store record with a time associated with the determination of geoposition data, wherein the data store record includes a plurality of geoposition data, each geoposition data of the plurality of geoposition data having a time associated with a determination of each of the geoposition data.

3. The non-transitory computer-readable medium of claim 1, wherein the physics model threshold is satisfied based on an evaluation of the current geoposition data with a geoposition data associated with a geoposition data in the geoposition data set that is closest in time to the current geoposition data.

4. The non-transitory computer-readable medium of claim 1, wherein the physics model threshold is based on a speed of the object determined based upon a distance over which the object moves and a time difference over which the distance is measured.

5. The non-transitory computer-readable medium of claim 1, wherein the physics model threshold is at least one of a height of the object, a weight of the object, a trajectory of the object, a speed of the object, or a momentum of the object.

6. The non-transitory computer-readable medium of claim 1, wherein the geoposition data is determined based upon a first object detection sensor of the at least one object detection sensor, and wherein the data store record includes geoposition data determined based upon a second object detection sensor.

7. The non-transitory computer-readable medium of claim 1, which further includes recording a traveler detection label with the data store record, the traveler detection label indicative of whether the physics model threshold of the detected object is satisfied.

8. The non-transitory computer-readable medium of claim 1, wherein the spatial sensor is at least one of a stereo camera, a Sonar device, a RADAR device, an RF device, a LiDAR device, a device operating using photogrammetry, and a single-snap stereo fusion device.

9. The non-transitory computer-readable medium of claim 1, which further includes determining a physical property data of the detected object based on the image scene data and the image-position model.

10. The non-transitory computer-readable medium of claim 9, wherein the physical property data including a plurality of physical property characteristics of the object including at least one of weight, height, trajectory, speed, or momentum.

11. A non-transitory computer-readable medium storing one or more instructions that, when executed by one or more processors, are configured to cause the one or more processors to perform operations comprising:
detecting an object in an image scene data to create a detected object, the image scene data representing an image scene in a field of view of at least one object detection sensor; and
determining a current geoposition data of the detected object using an image-position model, the image-position model determined by calibrating the at least one object detection sensor with a three-dimensional mapping provided by a spatial sensor;
determining an identity of the detected object to create a preliminary identity;
identifying a data store identity of a plurality of data store identities that matches the preliminary identity of the detected object, the plurality of data store identities corresponding to identities of a plurality of detected objects; and
recording the current geoposition data of the detected object with a data store record associated with the data store identity that matches the preliminary identity of the detected object; and
determining a movement indicator associated with the object based upon the current geoposition data of the detected object and a history of geoposition data associated with the detected object.

12. The transitory computer-readable medium of claim 11, wherein when the current geoposition data is recorded in the data store record with a time associated with the determination of geoposition data, wherein the data store record includes a plurality of geoposition data, each geoposition data of the plurality of geoposition data having a time associated with a determination of each of the geoposition data.

13. The transitory computer-readable medium of claim 11, which further includes determining a physical property data of the detected object based on the image scene data and the image-position model.

14. The transitory computer-readable medium of claim 11, wherein the data store record associated with the identity of the detected object includes geoposition data, the geoposition data including a plurality of past instances of current geoposition data of the detected object along with time or detection of the past instances of current geoposition data, and which further includes determining a dwell time of the geoposition data between an initial time that satisfies a position boundary threshold and an end time that satisfies a position boundary threshold.

15. The transitory computer-readable medium of claim 11, wherein the data store record associated with the identity of the detected object includes geoposition data, the geoposition data including a plurality of past instances of current geoposition data of the detected object along with time or detection of the past instances of current geoposition data, and which further includes determining that an observation impression of the detected object is satisfied if any time of the geoposition data satisfies a position boundary threshold.

16. The transitory computer-readable medium of claim 15, which further includes determining a probability that the geoposition data of the detected object was changed as direct result of the observation impression being satisfied relative to if the observation impression had not been satisfied.

17. The transitory computer-readable medium of claim 11, which further includes identifying, from a data store that includes the plurality of data store identities, a group of co-travelers having respective data store identities that satisfy a distance threshold over a co-travelling period of time.

18. The transitory computer-readable medium of claim 11, which further includes recording, in each data store record of respective co-travelers, a group identity that identifies the members of each co-traveler to the group.

19. The transitory computer-readable medium of claim 11, wherein the geoposition data is determined based upon a first object detection sensor of the at least one object detection sensor, and wherein the data store record includes geoposition data determined based upon a second object detection sensor.

20. The transitory computer-readable medium of claim 11, which further includes generating, with at least one object detection sensor, an image scene data representing an image scene in a field of view of the at least one object detection sensor.
